(19) United States
(12) Patent Application Publication
(10) Pub. No.: US 2013/0147870 A1
(43) Pub. Date: Jun. 13, 2013

(54) PRINTING METHOD FOR THREE-DIMENSIONAL PAINTING BY UV DIGITAL PRINTING DEVICE

(71) Applicants: Awen YEH, Taipei (TW); Kai LIU, New Taipei City (TW); Jim LIU, New Taipei City (TW); Chen-Ying CHENG, New Taipei City (TW); Chih-Yi LAI, New Taipei City (TW); Mao-Feng TU, New Taipei City (TW)

(72) Inventors: Awen YEH, Taipei (TW); Kai LIU, New Taipei City (TW); Jim LIU, New Taipei City (TW); Chen-Ying CHENG, New Taipei City (TW); Chih-Yi LAI, New Taipei City (TW); Mao-Feng TU, New Taipei City (TW)

(73) Assignees: DIGITAL PHOTONICS CORPORATION, NEW TAIPEI CITY (TW); ANDERSON INDUSTRIAL CORP., TAIPEI (TW)

(21) Appl. No.: 13/324,213

(22) Filed: Dec. 13, 2011

(51) Int. Cl. B41J 2/205

(52) U.S. Cl. 347/15

(57) ABSTRACT

A printing method for three-dimensional painting by UV digital printing device has acts of: First, preparing a printing device having a white print set and a color print set. Second, moving the printing device transversely from one side to the other side of an object for multiple times, wherein the two print sets respectively print on two adjacent zones. Third, moving the printing device longitudinally to next zone on the object. Fourth, repeating the second and third acts until the printing device moves over a last zone on the object. The printing device moves longitudinally after the printing device moves transversely to and fro to finish the height of a zone. Thus, the printing device completes all the heights and the colors in one time of longitudinal moving. Then printing consumes less time and the printing device therefore does not have to be orientated again.

### BACKGROUND OF THE INVENTION

1. Field of the Invention

The present invention relates to a printing method, especially to a printing method for three-dimensional painting by UV digital printing device that is faster and more accurate.

2. Description of the Prior Arts

A conventional printing method for three-dimensional painting uses UV-solidified ink. Multiple printing layers of the UV-solidified ink produce the three-dimensional effect on a painting. The conventional printing method comprise acts of:

(a) preparing a printing device having a white print set and a color print set, wherein the two print sets respectively have multiple nozzles, the white print set is mounted in front of the color print set, and the white print set uses the UV-solidified ink;

(b) determining a printing area on an object and determining a height on each position of the printing area on the object;

(c) moving the printing device to an initial position of the printing area on the object;

(d) moving the printing device transversely from one side to the other side of the object, and printing on the object based on the determined printing area and the determined height by the white print set while moving transversely;

(e) moving the printing device longitudinally to next zone of the determined printing area on the object;

(f) repeating step (d) and step (e) until the printing device moves over a last zone on the object;

(g) repeating steps (c) and (f) until finishing the enough height of each zone on the object;

(h) moving the printing device back to the initial position of the printing area on the object;

(i) moving the printing device transversely from one side to the other side of the object, wherein the white print set and the color print set print on two adjacent zones, the white print set finishes the height of the front zone, and the color print set finishes the coloring of the back zone;

(j) moving the printing device longitudinally to next zone on the object;

(k) repeating step (i) and step (j) until the printing device moves over the last zone on the object to produce the top layer of the UV-solidified ink and the colors of the object; and

When in step (i) for the first time, the color print set does not print because the color print set does not reach a first zone yet. When in step (i) for the last time, the white print set does not print because the white print set has moved over the last zone.

However, the conventional printing method for three-dimensional painting has three shortcomings as the following.

First, the printing device has to print in the same path for many times to layer the UV-solidified ink so that printing consumes too much time.

Second, every time the printing device moves back to the initial position on the object, the printing device has to be orientated again. The orientation easily causes inaccuracy so that each layer of the determined printing area on the object is inaccurately made.

Third, the height of the printing area decides the times for the printing device to repeat moving back and forth. Thus, the higher the height of the printing area is, the more times the printing device moves back to the initial position of the printing area, and then printing consumes more time.

To overcome the shortcomings, the present invention provides a printing method for three-dimensional painting by UV digital printing device to mitigate or obviate the aforementioned problems.

### SUMMARY OF THE INVENTION

The main objective of the present invention is to provide a printing method for three-dimensional painting by UV digital printing device that is faster and more accurate.

The printing method for three-dimensional painting by UV digital printing device in accordance with the present invention has acts of: First, preparing a printing device having a white print set and a color print set, wherein the two print sets respectively have multiple nozzles, the white print set is mounted in front of the color print set, and the white print set uses the UV-solidified ink. Second, moving the printing device transversely from one side to the other side of an object for multiple times, wherein the white print set and the color print set print on two adjacent zones, the white print set finishes the height of the front zone, and the color print set finishes the coloring of the back zone. Third, moving the printing device longitudinally to next zone on the object. Fourth, repeating the second and third acts until the printing device moves over a last zone on the object. The printing device moves longitudinally after the printing device moves transversely to and fro to finish the height of a zone. Thus, the printing device completes all the heights and the colors in one time of longitudinal moving. Then printing consumes less time and the printing device therefore does not have to be orientated again.

Other objectives, advantages and novel features of the invention will become more apparent from the following detailed description when taken in conjunction with the accompanying drawings.

### BRIEF DESCRIPTION OF THE DRAWINGS

FIG. 1 is a top schematic view of a first embodiment of a printing method for three-dimensional painting by UV digital printing device in accordance with the present invention;

FIG. 2 is a schematic view of a printing method for three-dimensional painting by UV digital printing device in FIG. 1, showing the position of the first move;

FIG. 3 is a schematic view of a printing method for three-dimensional painting by UV digital printing device in FIG. 1, showing the position of the second move;

FIG. 4 is a schematic view of a printing method for three-dimensional painting by UV digital printing device in FIG. 1, showing the position of the third move;

FIG. 5 is a side schematic view of a printing method for three-dimensional painting by UV digital printing device in FIG. 1, showing the layering of the UV-solidified ink by the first move;

FIG. 6 is a side schematic view of a printing method for three-dimensional painting by UV digital printing device in FIG. 1, showing the layering of the UV-solidified ink by the second move;

FIG. 7 is a side schematic view of a printing method for three-dimensional painting by UV digital printing device in FIG. 1, showing the layering of the UV-solidified ink by the third move;

FIG. 8 is a first flow chart of a printing method for three-dimensional painting by UV digital printing device in FIG. 1; and

FIG. 9 is a second flow chart of a printing method for three-dimensional painting by UV digital printing device in FIG. 1.

### DETAILED DESCRIPTION OF THE PREFERRED EMBODIMENTS

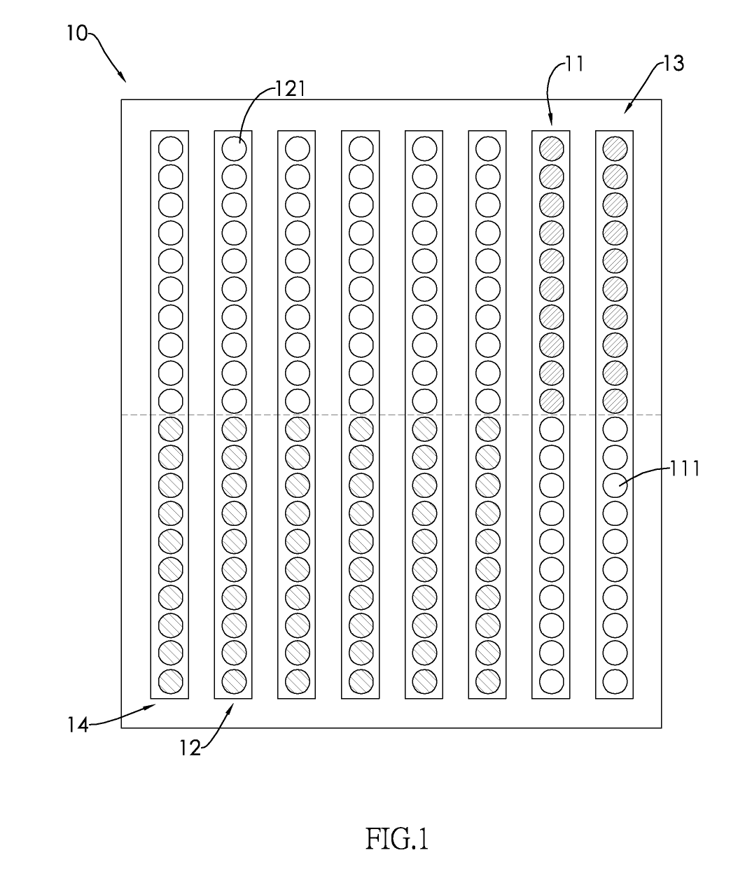

With reference to FIG. 1, a printing method for three-dimensional painting by UV digital printing device in accordance with the present invention comprises acts of pre-procedure and printing procedure.

The pre-procedure comprises obtaining an original data of an object, processing the original data of the object, determining a printing material and inputting the processed image file.

Obtaining an original data of an object comprises the following steps. Obtaining a high-resolution color image file of an object by scanning a color image of the object. Obtaining a three dimensional outline data of the object by scanning a three-dimensional outline of the object.

Processing the original data of the object by computer program such as Adobe Photoshop™ or Adobe Illustrator™ comprises the following steps. Adjusting the computer file of high definition colors and transforming it into a computer file of color layers. Combining the computer file of color layers and the computer file of three-dimensional outline into a computer file in tiff format.

Determining a proper material, such as MDF, PVC, PC, PMMA, tile, aluminum composite panel, aluminum panel, metal panel, glass and material with zero or low absorbency. However, fabric, silk, carpet and material with high absorbency are improper materials.

Inputting the computer file in tiff format into a printing device.

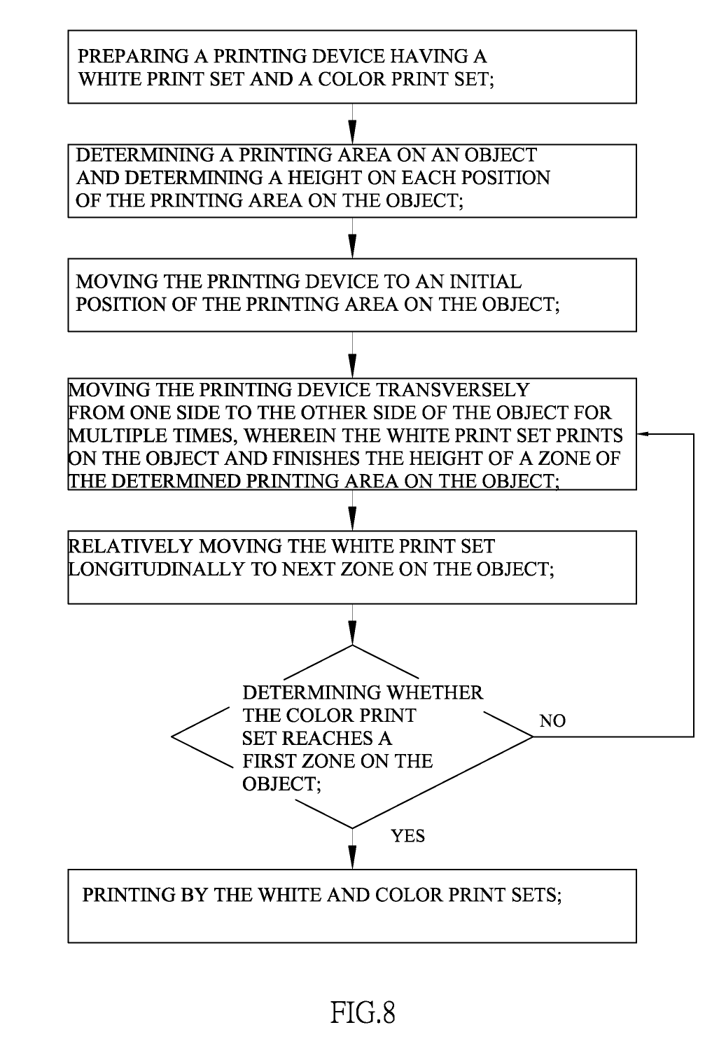

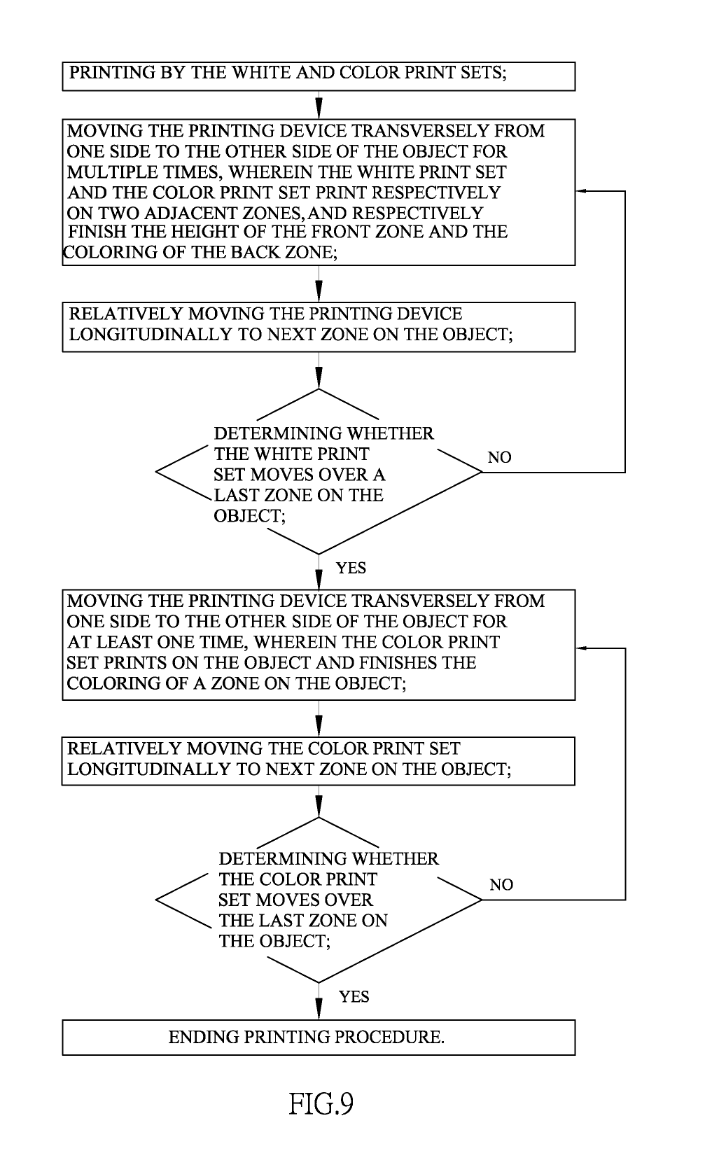

With reference to FIGS. 8 and 9, the printing procedure comprises preparing the devices, printing by the white print set, printing by the white and color print sets, and printing by the color print set.

Preparing the devices comprises the following steps (a) to (c).

(a) With reference to FIG. 1, preparing the printing device 10 having at least one white nozzle set 11 and at least one color nozzle set 12. The at least one white nozzle set 11 is transversely formed separately on the printing device 10. Each one of the at least one white nozzle set 11 has multiple nozzles 111 divided into two equal parts. The forward part of the nozzles 111 of the at least one white nozzle set 11 is a white print set 13. The white print set 13 uses the UV-solidified ink. The at least one color nozzle set 12 is adjacent to the at least one white nozzle set 11 and is transversely formed separately on the printing device 10. Each one of the at least one color nozzle set 12 has multiple nozzles 121 divided into two equal parts. The backward part of the nozzles 121 of the at least one color nozzle set 12 is a color print set 14. The longitudinal distance of the area printed by the white print set 13 is equal to the longitudinal distance of the area printed by the color print set 14.

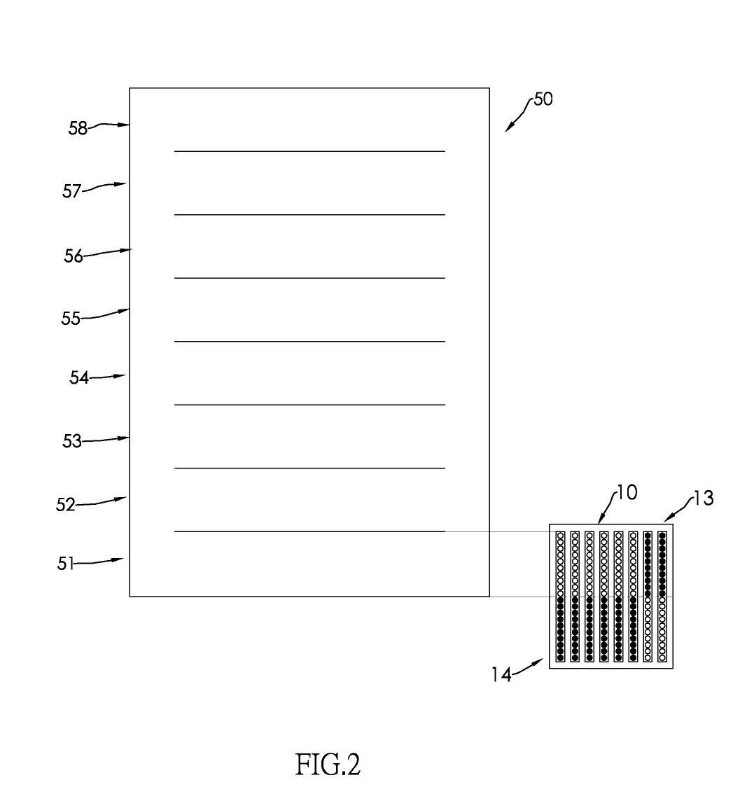

(b) With reference to FIG. 2, determining a printing area on an object 50 and determining a height on each position of the printing area on the object 50. The printing area on an object 50 is divided longitudinally into multiple zones. The longitudinal distance of the zone 51 on the object 50 is equal to the longitudinal distance of the area printed by the white print set 13 or the color print set 14.

(c) Moving the printing device 10 to an initial position of the printing area on the object 50.

Printing by the white print set 13 comprises the following steps (d) to (f).

(d) With reference to FIGS. 2 and 5, moving the printing device 10 transversely from one side to the other side of an object 50 for multiple times. The white print set 13 prints on the object 50 based on the determined printing area and the determined height while moving transversely and finishes the height of a zone on the object 50.

(e) Moving the white print set 13 longitudinally to next zone on the object 50.

(f) Determining whether the color print set 14 reaches a first zone 51 on the object 50. If the color print set 14 reaches the first zone 51, then proceed to next step. If the color print set 14 does not reach the first zone 51, then proceed with step (d).

Printing by the white and color print sets 13, 14 comprises the following steps (g) to (i).

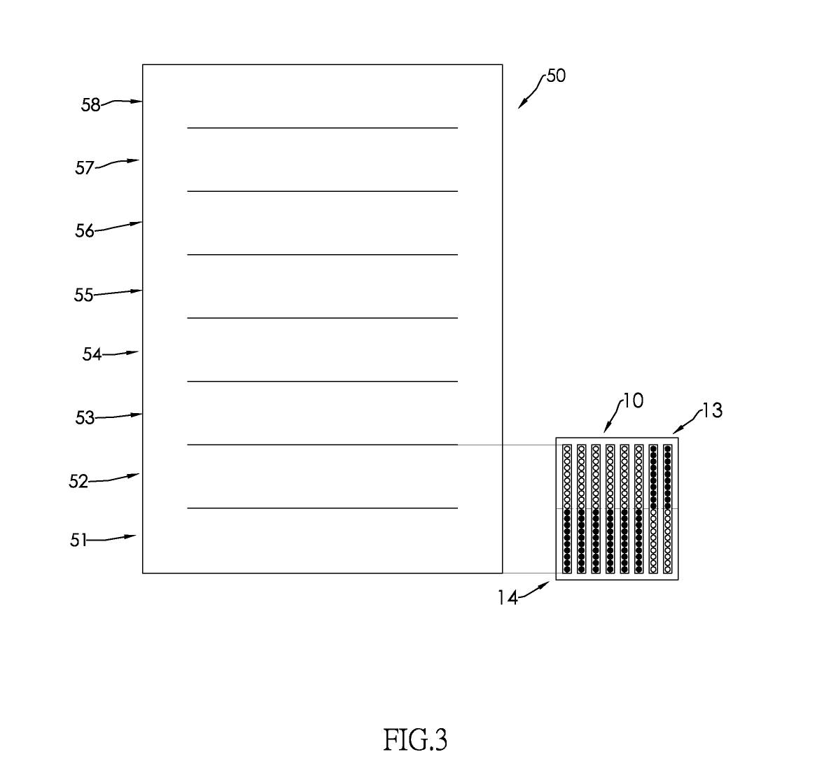

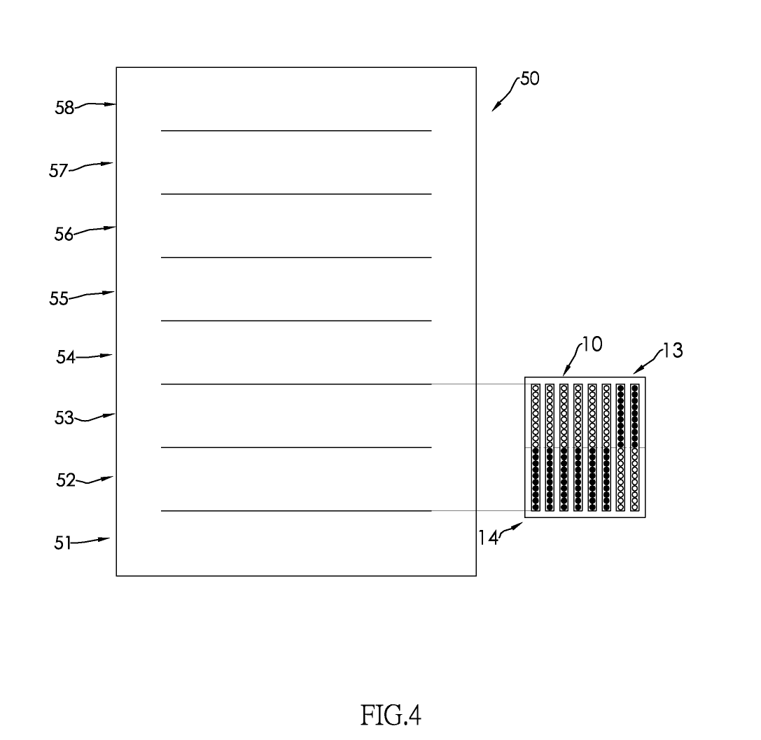

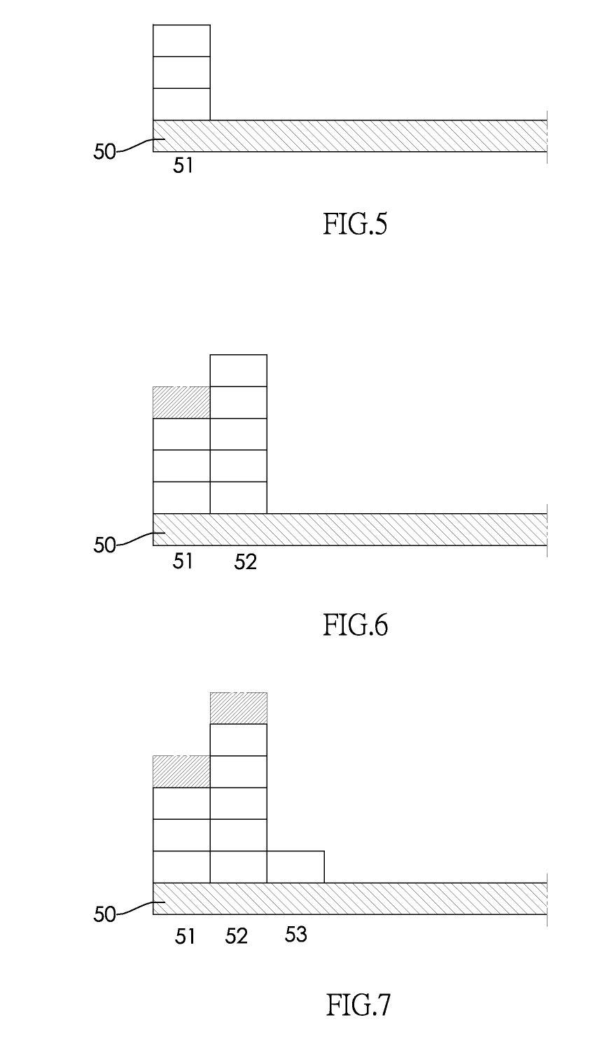

(g) With reference to FIGS. 3, 4, 6 and 7, moving the printing device 10 transversely from one side to the other side of the object 50 for multiple times. The white print set 13 and the color print set 14 print respectively on two adjacent zones 51, 52 based on the determined printing area and the determined height while moving transversely. The white print set 13 finishes the height of the front zone 52, and the color print set 14 finishes the coloring of the back zone 51.

(h) Moving the printing device 10 longitudinally to next zone on the object 50.

(i) Determining whether the white print set 13 moves over a last zone 58 on the object 50. If the white print set 13 moves over the last zone 58, then proceed to next step. If the white print set 13 does not move over the last zone 58, then proceed with step (g).

Printing by the color print set 14 comprises the following steps (j) to (l).

(j) Moving the printing device 10 transversely from one side to the other side of the object 50 for at least one time. The color print set 14 prints on the object 50 based on the determined printing area while moving transversely and finishes the coloring of a zone on the object 50.

(k) Moving the color print set 14 longitudinally to next zone on the object 50.

(l) Determining whether the color print set 14 moves over the last zone 58 on the object 50. If the color print set 14 moves over the last zone 58, then the printing procedure is ended. If the color print set 14 does not move over the last zone 58, then proceed to step (j).

With reference to FIGS. 1 and 2, after the object 50 is printed by the white print set 13, the object 50 is illuminated by UV light soon to solidify the UV-solidified ink.

In step (e), step (h) and step (k), the printing device 10 moves longitudinally on the starting side when the printing device 10 moves transversely for odd number of times in the previous step. The printing device 10 moves longitudinally on the other side when the printing device 10 moves transversely for even number of times in the previous step.

In step (g), the color print set 14 can print in two ways as follows:

First, the color print set 14 prints only in the last transverse moving, and the color print set 14 prints all the color ink in one time.

Second, the color print set 14 prints every time the printing device 10 moves transversely. Each time the amount of the color ink printed by the color print set 14 is planned by computer program. Therefore, after the color print set 14 prints in the same zone for multiple times, the colors of the zone are achieved.

In step (j), the color print set 14 can print in two ways as follows:

First, the color print set 14 moves from one side to the other side of the object 50 for just one time, and the color print set 14 prints all the color ink in one time as well.

Second, the color print set 14 moves from one side to the other side of the object 50 for multiple times, and the color print set 14 prints every time the printing device 10 moves transversely. Each time the amount of the color ink printed by the color print set 14 is planned by computer program. Therefore, after the color print set 14 prints in the same zone for multiple times, the colors of the zone are achieved.

The printing device 10 moves longitudinally after the printing device 10 moves transversely to and fro to finish the height of a zone. Thus, the printing device 10 completes all the heights and the colors in one time of longitudinal moving. With the aforementioned description, the method has the following advantages.

First, the printing device 10 completes all the heights and the colors in only one time of longitudinal moving from the first zone 51 to the last zone 58, so printing consumes less time.

Second, the printing device 10 does not have to move back to the initial position of the object 50, so the printing device 10 does not have to be orientated again. Printing has no inaccuracy caused by the re-orientation, and is therefore more accurate.

Third, the height of the object 50 is decided by the times the printing device 10 repeats transverse moving, and the printing device 10 can move transversely for many times in a short time. Thus, printing consumes less time.

By consuming less time to complete the painting, the printing produces higher heights in a short time, and by the colors printed without re-orientation, the printing produces more accurate colors. With the both features, the printing produces the effect of wood textures or a three-dimensional, in-depth texture of an oil painting.

In a preferred embodiment, all the nozzles of each one of the at least one white nozzle set or color nozzle set print, and the at least one white nozzle set is mounted in front of the at least one color nozzle set.

In a preferred embodiment, the longitudinal distance of the area printed by the white print set is unequal to the longitudinal distance of the area printed by the color print set. For example, the longitudinal distance of the area printed by the white print set is three times more than the longitudinal distance of the area printed by the color print set, and the distance of the printing device moving longitudinally each time is equal to the longitudinal distance of the area printed by the color print set. Then the three longitudinal parts of the white print set respectively move transversely to and fro for multiple times on the same zone, and each longitudinal part of the white print set can print for many times on the zone as well. Thus, it further strengthens the achievement of the height of the zone.

In a preferred embodiment, the distance of the printing device moving longitudinally each time is unequal to the longitudinal distance of the area printed by the white print set or the color print set. For example, the longitudinal distance of the area printed by the white print set is four times more than the longitudinal distance of the printing device moving longitudinally each time. Then the four longitudinal parts of the white print set respectively move transversely to and fro for multiple times on the same zone, and each longitudinal part of the white print set can print for many times on the zone as well. Thus, it further strengthens the achievement of the height of the zone.

In a preferred embodiment, in step (e), step (h) and step (k), the object moves backward longitudinally rather than the printing device moves forward longitudinally.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A printing method for three-dimensional painting by UV digital printing device comprising acts of:
(a) preparing a printing device having a white print set and a color print set, wherein the two print sets respectively have multiple nozzles, the white print set is mounted in front of the color print set, and the white print set uses the UV-solidified ink;
(b) determining a printing area on an object and determining a height on each position of the printing area on the object;
(c) moving the printing device to an initial position of the printing area on the object;
(d) moving the printing device transversely from one side to the other side of the object for multiple times, printing on the object based on the determined printing area and the determined height by the white print set while moving transversely, and the white print set finishing the height of a zone of the determined printing area on the object;
(e) relatively moving the white print set longitudinally to next zone on the object;
(f) determining whether the color print set reaches a first zone on the object; if the color print set reaches the first zone, then proceeding to next step; if the color print set does not reach the first zone, then proceeding with step (d);
(g) moving the printing device transversely from one side to the other side of the object for multiple times, wherein the white print set and the color print set print respectively on two adjacent zones based on the determined printing area and the determined height while moving transversely, the white print set finishes the height of the front zone, and the color print set finishes the coloring of the back zone;
(h) relatively moving the printing device longitudinally to next zone on the object;
(i) determining whether the white print set moves over a last zone on the object; if the white print set moves over the last zone, then proceeding to next step; if the white print set does not move over the last zone, then proceeding with step (g);
(j) moving the printing device transversely from one side to the other side of the object for at least one time, printing on the object based on the determined printing area by the color print set while moving transversely, and the color print set finishing the coloring of a zone on the object;
(k) relatively moving the color print set longitudinally to next zone on the object; and
(l) determining whether the color print set moves over the last zone on the object; if the color print set moves over the last zone, then the printing being ended; if the color print set does not move over the last zone, then proceeding with step (j).

2. The printing method for three-dimensional painting by UV digital printing device as claimed in claim 1, wherein the longitudinal distance of the area printed by the white print set is equal to the longitudinal distance of the area printed by the color print set.

3. The printing method for three-dimensional painting by UV digital printing device as claimed in claim 2, wherein the printing device has
at least one white nozzle set transversely formed separately on the printing device and each one of the at least one white nozzle set having
multiple nozzles divided into two equal parts, the forward part being the white print set; and
at least one color nozzle set adjacent to the at least one white nozzle set and transversely formed separately on the printing device, and each one of the at least one color nozzle set having
multiple nozzles divided into two equal parts, the backward part being the color print set.

4. The printing method for three-dimensional painting by UV digital printing device as claimed in claim 1, wherein in step (g), the color print set prints every time the printing device moves from one side to the other side of the object, and each time the amount of the ink printed by the color print set is planned by computer program; therefore, after the color print set prints in the same zone for multiple times, the colors of the zone are achieved.

5. The printing method for three-dimensional painting by UV digital printing device as claimed in claim 2, wherein in step (g), the color print set prints every time the printing device moves from one side to the other side of the object, and each time the amount of the ink printed by the color print set is planned by computer program; therefore, after the color print set prints in the same zone for multiple times, the colors of the zone are achieved.

6. The printing method for three-dimensional painting by UV digital printing device as claimed in claim 3, wherein in step (g), the color print set prints every time the printing device moves from one side to the other side of the object, and each time the amount of the ink printed by the color print set is planned by computer program; therefore, after the color print set prints in the same zone for multiple times, the colors of the zone are achieved.

7. The printing method for three-dimensional painting by UV digital printing device as claimed in claim 1, wherein in step (g), the color print set prints only in the last transverse moving, and the color print set prints all the color ink in one time.

8. The printing method for three-dimensional painting by UV digital printing device as claimed in claim 2, wherein in step (g), the color print set prints only in the last transverse moving, and the color print set prints all the color ink in one time.

9. The printing method for three-dimensional painting by UV digital printing device as claimed in claim 3, wherein in step (g), the color print set prints only in the last transverse moving, and the color print set prints all the color ink in one time.

10. The printing method for three-dimensional painting by UV digital printing device as claimed in claim 1, wherein the longitudinal distance of the zone on the object is equal to the longitudinal distance of the area printed by the color print set.

11. The printing method for three-dimensional painting by UV digital printing device as claimed in claim 2, wherein the longitudinal distance of the zone on the object is equal to the longitudinal distance of the area printed by the color print set.

12. The printing method for three-dimensional painting by UV digital printing device as claimed in claim 3, wherein the longitudinal distance of the zone on the object is equal to the longitudinal distance of the area printed by the color print set.

13. The printing method for three-dimensional painting by UV digital printing device as claimed in claim 4, wherein the longitudinal distance of the zone on the object is equal to the longitudinal distance of the area printed by the color print set.

14. The printing method for three-dimensional painting by UV digital printing device as claimed in claim 5, wherein the longitudinal distance of the zone on the object is equal to the longitudinal distance of the area printed by the color print set.

15. The printing method for three-dimensional painting by UV digital printing device as claimed in claim 6, wherein the longitudinal distance of the zone on the object is equal to the longitudinal distance of the area printed by the color print set.

16. The printing method for three-dimensional painting by UV digital printing device as claimed in claim 7, wherein the longitudinal distance of the zone on the object is equal to the longitudinal distance of the area printed by the color print set.

17. The printing method for three-dimensional painting by UV digital printing device as claimed in claim 8, wherein the longitudinal distance of the zone on the object is equal to the longitudinal distance of the area printed by the color print set.

18. The printing method for three-dimensional painting by UV digital printing device as claimed in claim 9, wherein the longitudinal distance of the zone on the object is equal to the longitudinal distance of the area printed by the color print set.
